(19) United States
(12) Patent Application Publication
(10) Pub. No.: US 2016/0316428 A1
(43) Pub. Date: Oct. 27, 2016

(54) Method of Configuring a Number of Antennas and Wireless Device

(71) Applicant: MEDIATEK INC., HSIN-CHU (TW)

(72) Inventors: Yuan-Chin Wen, Taipei City (TW); Tsai-Yuan Hsu, Hsinchu County (TW); Shun-Yong Huang, Hsinchu City (TW)

(21) Appl. No.: 15/131,032

(22) Filed: Apr. 18, 2016

Related U.S. Application Data
(60) Provisional application No. 62/152,042, filed on Apr. 24, 2015.

(51) Int. Cl. H04W 52/02

(52) U.S. Cl. CPC H04W 52/0206; H04W 84/12

(57) ABSTRACT

A method of configuring a number of antennas utilized in a wireless device within a wireless network system is disclosed. The wireless device comprises a plurality of antennas and transmits data to a destination wireless device using the plurality of antennas. The method comprises transmitting a first frame comprising a first number information to the destination wireless device; and transmitting data to the destination wireless device using a plurality of remaining antennas after the destination wireless device receives the first frame.

### CROSS REFERENCE TO RELATED APPLICATIONS

This application claims the benefit of U.S. provisional application No. 62/152,042, filed on Apr. 24, 2015 and incorporated herein by reference.

### BACKGROUND

The present invention relates to a method of configuring a number of antennas and a wireless device, and more particularly, to a method and a wireless device capable of changing a number of antennas utilized for transmission to a destination wireless device.

As a demand for wireless service increases, wireless stations are usually demanded to be equipped with a plurality of antennas so as to provide higher transmission rate. For example, a first wireless station equipped with four antennas may perform a spatial multiplexing transmission to a second wireless station, which is also equipped with four antennas. A four-time transmission rate may be achieved under a condition that the second wireless station is able to successfully decode all data packets transmitted from the first wireless station, which means that the second wireless station is informed in advanced that the first wireless station would transmit data packets via the four antennas.

Meanwhile, wireless applications processed by each wireless station (e.g., the first wireless station) may increase as well. In some circumstances, the first wireless station may like to divert some of its four antennas for performing applications other than transmitting to the second wireless station. If the first wireless station just diverts a part of antennas for other applications without telling the second wireless station, the second wireless station may fail to decode data packets transmitted by the first wireless station. The transmission rate may not be enhanced. Furthermore, without receiving an acknowledge information from the second wireless station, the first wireless station may keep re-transmitting the same data packet to the second wireless station, which causes an inefficiency of transmission power of the first wireless station.

Therefore, it is necessary to improve the prior art.

### SUMMARY

It is therefore a primary objective of the present invention to provide method of configuring a number of antennas and a wireless device, to improve over disadvantages of the prior art.

An embodiment of the present invention discloses a method of configuring a number of antennas, utilized in a wireless device within a wireless network system. The wireless device comprises a plurality of antennas and transmits data to a destination wireless device using the plurality of antennas. The method comprises transmitting a first frame comprising a first number information to the destination wireless device, wherein the first number information indicates a number of suspended antenna; and transmitting data to the destination wireless device using a remaining antenna after the destination wireless device receives the first frame, wherein the remaining antenna is a part of the plurality of antennas.

An embodiment of the present invention further discloses a wireless device comprising a plurality of antennas, configured to transmit data to a destination wireless device; a processing unit; and a storage unit configured to store a programming code. The programming code instructs the processing unit to perform steps of transmitting a first frame comprising a first number information to the destination wireless device, wherein the first number information indicates a number of suspended antenna; and transmitting data to the destination wireless device using a remaining antenna after the destination wireless device receives the first frame, wherein the remaining antenna is a part of the plurality of antennas.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless device operating within a wireless system according to an embodiment of the present invention.

FIG. 2 is a schematic diagram of a configuring process according to an embodiment of the present invention.

FIG. 3 is a schematic diagram of a configuring process according to an embodiment of the present invention.

FIG. 4 is a schematic diagram of a frame format.

### DETAILED DESCRIPTION

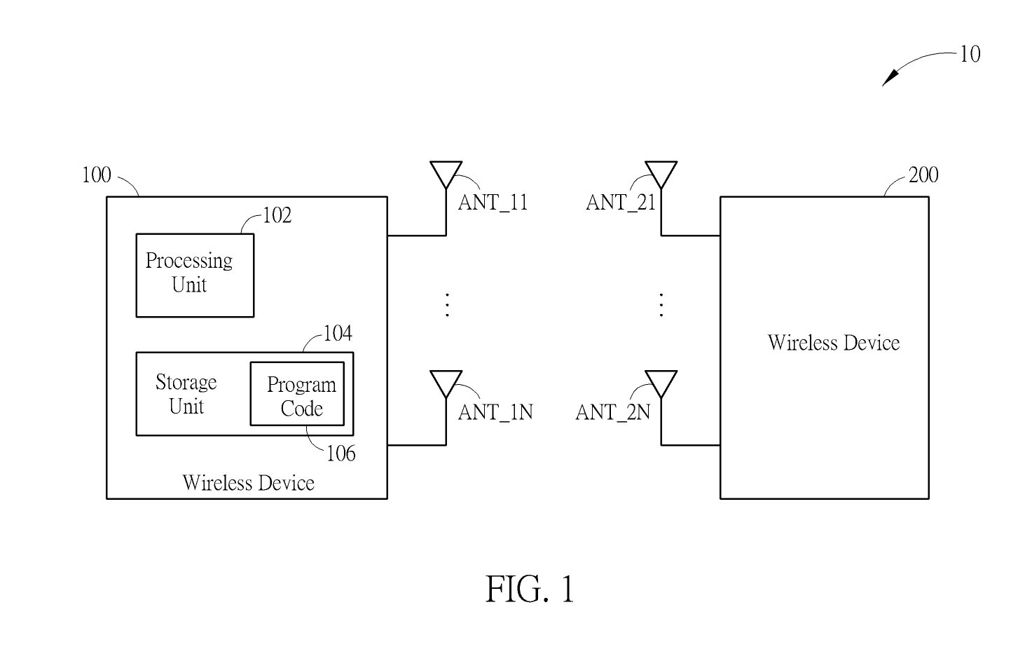

Please refer to FIG. 1, which is a schematic diagram of a wireless system 10 according to an embodiment of the present invention. The wireless communication system 10 comprises a wireless device 100 and a wireless device 200. The wireless communication system 10 may be a wireless local area network (WLAN) system with multiple input multiple output (MIMO) transmission. The wireless communication system 10 may be compatible with a standard of IEEE 802.11n. The wireless devices 100, 200 may be stationary access points (AP), or mobile electronic devices such as smart phones, tablet computers, laptop computers, etc. The wireless device 100 comprises a processing unit 102, a storage unit 104, and antennas ANT1_1-ANT1_N. The antennas ANT1_1-ANT1_N are originally configured to perform data transmission to a destination wireless device of the wireless device 100 in general. In the current embodiment, the destination wireless device of the wireless device 100 is the wireless device 200, where the wireless device 200 also comprises antennas ANT2_1-ANT2_N configured to receive data packets transmitted by the wireless device 100.

Meanwhile, the wireless device 100 may have to perform other wireless applications while performing data transmission to the wireless device 200 at the same time. In some circumstances, the wireless device 100 may divert a part of the antennas ANT1_1-ANT1_N from transmitting data to the wireless device 200, so as to perform other wireless applications via the part of the antennas ANT1_1-ANT1_N. For example, in an embodiment, the wireless device 100 may choose the antennas ANT1_1-ANT1_K for performing other wireless applications and continue transmitting data to the wireless device 200 using the antennas ANT1_K+1-ANT1_N. In other words, the antennas ANT1_1-ANT1_K are suspended from transmitting data toward the wireless device 200, and the antennas ANT1_K+1-ANT1_N remain transmitting data toward the wireless device 200. Before the wireless device 100 diverts the antennas ANT1_1-ANT1_K to perform other wireless applications, the wireless device 100 has to inform the wireless device 200 about a changed number of antennas utilized for transmission toward the wireless device 200 in advance, such that the wireless device 200 is able to decode the data packets from the wireless device 100 correctly.

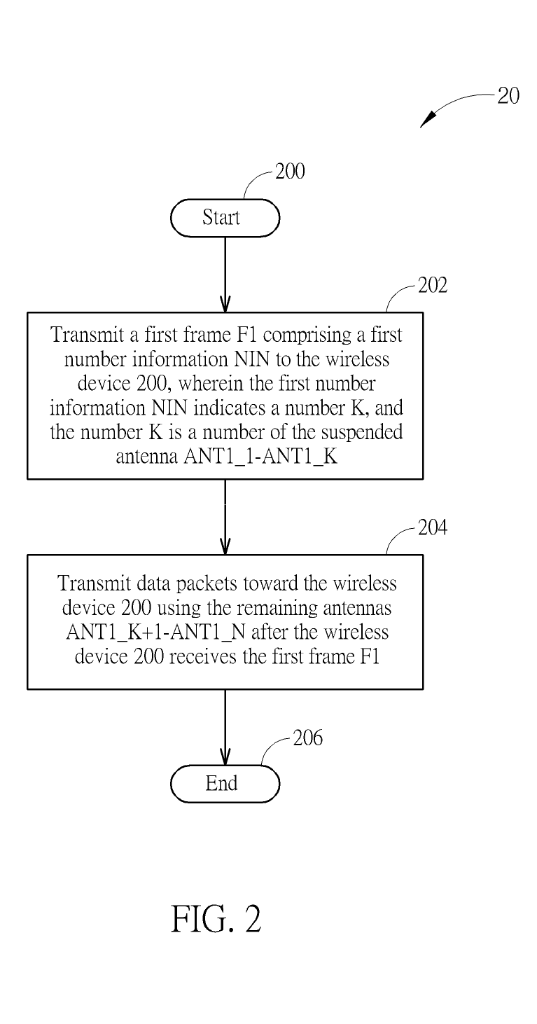

Methods of the wireless device 100 informing a number of antennas being suspended from transmitting data toward the wireless device 200, equivalent to the wireless device 100 configuring a number of antennas being used to transmitting data toward the wireless device 200, is referred to FIG. 2, which is a schematic diagram of a configuring process 20 according to an embodiment of the present invention. The configuring process 20 may be compiled as a part of a program code 106 stored in the storage unit 104. The program code 106 is configured to instruct the process unit 102 to execute the configuring process 20. As FIG. 2 shows, the configuring process 20 comprises the following steps:

Step 200: Start.

Step 202: Transmit a first frame F1 comprising a first number information NIN to the wireless device 200, wherein the first number information NIN indicates a number K, and the number K is a number of the suspended antenna ANT1_-ANT1_K.

Step 204: Transmit data packets toward the wireless device 200 using the remaining antennas ANT1_K+1-ANT1_N after the wireless device 200 receives the first frame F1.

Step 206: End.

According to the configuring process 20, the wireless device 100 is able to inform the wireless device 200 about the changed number of antennas utilized for transmission toward the wireless device 200, such that the wireless device 200 is able to decode the data packets from the wireless device 100 correctly.

In detail, in Step 202, the wireless device 100 transmits the first frame F1, comprising the first number information NIN indicating the number K, to the wireless device 200, where the number K is the number of the suspended antenna ANT1_1-ANT1_K or the number of suspended antennas. The suspended antennas ANT1_1-ANT1_K, as a part of the antennas ANT1_1-ANT1_N, are suspended from transmitting data toward the wireless device 200.

In Step 204, the wireless device 100 transmits data packets toward the wireless device 200 via the remaining antennas ANT1_K+1-ANT1_N after the wireless device 200 receives the first frame F1. The remaining antennas ANT1_K+1-ANT1_N, as another part of the antennas ANT1_1-ANT1_N, continue transmitting data toward the wireless device 200. Specifically, in an embodiment, the wireless device 200 may send the wireless device 100 an acknowledge packet after the wireless device 200 receives the first frame F1, and the wireless device 100 may transmits data packets toward the wireless device 200 merely via the remaining antennas ANT1_K+1-ANT1_N after the wireless device 100 receives the acknowledge packet.

Notably, a transmission rate using only the antennas ANT1_K+1-ANT1_N is lower than a transmission rate using all of the antennas ANT1_1-ANT1_N. When wireless device 100 finishes other application occupying the antenna ANT1_1-ANT1_K, the wireless device 100 may like to recover all of the antennas ANT1_1-ANT1_N back to performing data transmission toward the wireless device 200. Similarly, the wireless device 100 may need to inform the wireless device 200 that the number of antennas utilized for transmission toward the wireless device 200 would be changed again. This time, the wireless device 100 would recover all of the antennas ANT1_1-ANT1_N back to performing data transmission toward the wireless device 200.

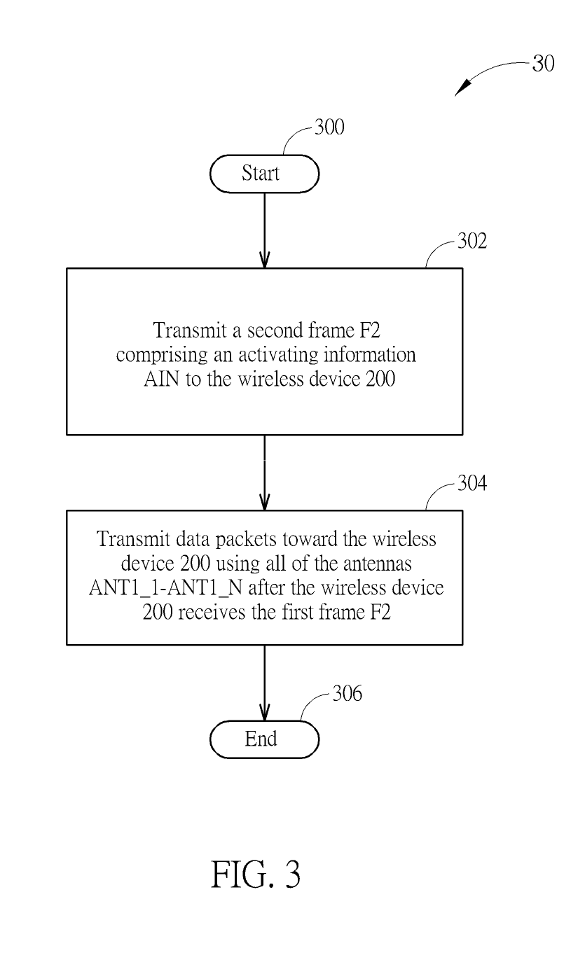

Methods of the wireless device 100 informing the wireless device 200 that the wireless device 100 tends to recover all of the antennas ANT1_1-ANT1_N back to performing data transmission toward the wireless device 200 is referred to FIG. 3, which is a schematic diagram of a configuring process 30 according to an embodiment of the present invention. The configuring process 30 may be compiled as another part of the program code 106, stored in the storage unit 104 and configured to instruct the process unit 102 to execute the configuring process 30. As FIG. 3 shows, the configuring process 30 comprises the following steps:

Step 300: Start.

Step 302: Transmit a second frame F2 comprising an activating information AIN to the wireless device 200.

Step 304: Transmit data packets toward the wireless device 200 using all of the antennas ANT1_1-ANT1_N after the wireless device 200 receives the first frame F2.

Step 306: End.

According to the configuring process 30, the wireless device 100 is able to inform the wireless device 200 that the wireless device 100 tends to recover all of the antennas ANT1_1-ANT1_N back to performing data transmission toward the wireless device 200, such that the wireless device 200 is able to decode the data packets from the wireless device 100 correctly. Details of the configuring process 30 are similar to the configuring process 20, which is not narrated herein.

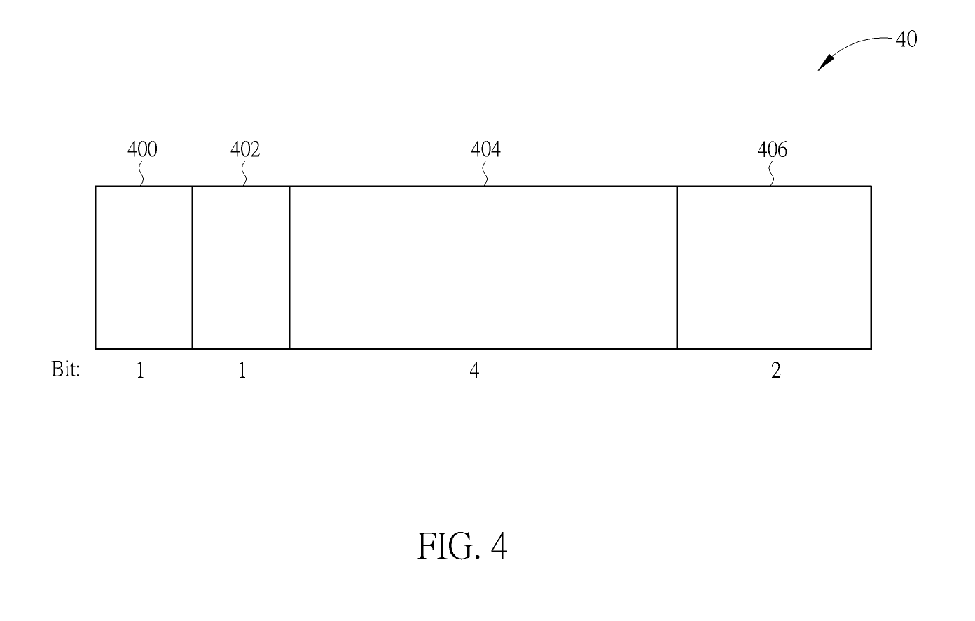

Notably, the first frame F1 and the second frame F2 may have a same frame format (or frame structure), and the first number information NIN and the activating information AIN may lie in different field of the same frame format. For example, the same frame format may be a predefined format in a power save mode in which a part of antennas is announced to be turned off. More particularly, when wireless communication system 10 is under (or be compatible with) a standard of IEEE 802.11n, the same frame format may be a predefined format in a spatial multiplexing power save (SMPS) mode. For example, please refer to FIG. 4, which is a schematic diagram of a frame format 40 in the SMPS mode. The frame format 40 comprises a SMPS enabled field 400, a spatial multiplexing (SM) mode field 402, a SMPS number field 404 and a reserve field 406. Lengths of the frame format 40, the SMPS enabled field 400, the SM mode field 402, the SMPS number field 404, and the reserve field 406 are 8 bits, 1 bit, 1 bit, 4 bits, 2 bits, respectively. The first number information NIN may lie in the SMPS number field 404, and the activating information AIN may lie in the SMPS enabled field 400.

Notably, the embodiments stated in the above are utilized for illustrating concepts of the present invention. Those skilled in the art may make modifications and alternations accordingly, and not limited herein. For example, the processing unit 102 may be a microprocessor or an application-specific integrated circuit (ASIC). The storage unit 104 may be read-only memory (ROM), random-access memory (RAM), non-volatile memory (e.g., an electrically erasable programmable read only memory (EEPROM) or a flash memory), CD-ROMs, magnetic tapes, floppy disks, optical data storage devices, etc., and not limited herein.

In summary, the wireless device of the present invention is able to inform the destination wireless device thereof about the changed number of antennas utilized for transmission toward the destination wireless device via the predefined frame format in the SMPS mode of the WLAN, such that the destination wireless device is able to decode the data packets from the wireless device correctly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of configuring a number of antennas in a wireless device within a wireless network system, the wireless device comprising a plurality of antennas and transmitting data to a destination wireless device using the plurality of antennas, the method comprising:
transmitting a first frame comprising a first number information to the destination wireless device, wherein the first number information indicates a number of suspended antenna; and
transmitting data to the destination wireless device using a remaining antenna after the destination wireless device receives the first frame, wherein the remaining antenna is a part of the plurality of antennas.

2. The method of claim 1, further comprising:
transmitting a second frame comprising an activating information to the destination wireless device; and
transmitting data to the destination wireless device using all of the plurality of antennas after the destination wireless device receives the second frame.

3. The method of claim 2, wherein the first frame and the second frame are in a same frame format.

4. The method of claim 3, wherein the frame format of the first frame and the second frame are used in a power save mode of the wireless network system.

5. The method of claim 4, wherein the power save mode is a spatial multiplexing power save (SMPS) mode, and the wireless network system is a wireless local area network system.

6. The method of claim 1, wherein the first number information indicates which antenna in the plurality of antennas is suspended from being used for transmitting data to the destination wireless device.

7. A wireless device, comprising:
a plurality of antennas, configured to transmit data to a destination wireless device;
a processing unit; and
a storage unit, configured to store a programming code, the programming code instructing the processing unit to perform following steps:
transmitting a first frame comprising a first number information to the destination wireless device, wherein the first number information indicates a number of suspended antenna; and
transmitting data to the destination wireless device using a remaining antenna after the destination wireless device receives the first frame, wherein the remaining antenna is a part of the plurality of antennas.

8. The device of claim 7, wherein the processor is further configured to perform following steps:
transmit a second frame comprising an activating information to the destination wireless device; and
transmit data to the destination wireless device using all of the plurality of antennas after the destination wireless device receives the second frame.

9. The device of claim 8, wherein the first frame and the second frame are in a same frame format.

10. The device of claim 9, wherein the frame format of the first frame and the second frame are used in a power save mode of the wireless network system.

11. The device of claim 10, wherein the power save mode is a spatial multiplexing power save (SMPS) mode, and the wireless network system is a wireless local area network system.

12. The device of claim 7, wherein the first number information indicates which antenna in the plurality of antennas is suspended from being used for transmitting data to the destination wireless device.
